(19) United States
(12) Patent Application Publication
(10) Pub. No.: US 2018/0344059 A1
(43) Pub. Date: Dec. 6, 2018

(54) ADJUSTABLE WALL HOOK

(71) Applicant: Ausencio Rene Castilleja, Seguin, TX (US)

(72) Inventor: Ausencio Rene Castilleja, Seguin, TX (US)

(21) Appl. No.: 15/469,478

(22) Filed: Mar. 24, 2017

(51) Int. Cl. A47G 1/20; F16M 13/02

(52) U.S. Cl. CPC A47G 1/202; F16M 13/02

(57) ABSTRACT

The present invention provides an adjustable hanging device that has a hook and which is mounted on a vertical solid surface, such as a wall. An object may be hung from the hook to display the object. The position of the hook when mounted may be adjusted vertically to change the height of the object. The present invention includes an adjustment screw to adjust the hook either without the object or while the object is hung from the hook. The adjustable screw is stabilized during adjustment to provide more accurate and easily achieved adjustment. A user may easily hang an object on the hanging device, for example, by the lip of a picture frame or by a metal loop or wire affixed to the object.

### CROSS-REFERENCE TO RELATED APPLICATIONS

N/A

### STATEMENT REGARDING FEDERALLY SPONSORED RESEARCH OR DEVELOPMENT

N/A

### FIELD OF THE INVENTION

The present invention described herein relates to adjustable hanging devices for hanging objects and, more particularly, which are mounted on a wall.

### BACKGROUND

Hanging objects, such as pictures or paintings, on a wall using a hanging device, requires fasteners for the hanging device to be fixedly attached to the wall and the object to be hung on the hanging device. In order to enable the object to be hung at the desired position or orientation, fastener pilot hole measurements for the locations of the fasteners must be made for the hanging device and marked on the wall for the location of the fastener pilot holes into the wall. A recurring problem with the position of the fasteners and the hanging device is that the once the fastener is attached to the wall and the object hung on the hanging device, the location may be deemed incorrect. This may be due to errors in the measurement of the dimensions of the article to be hung, the marking of the location of the pilot hole, or esthetic disagreement of the location in which the object is hung. This is often a result of an inappropriate height for the hanging device that is erroneous by a few centimeters or less. If the height of the hanging device is incorrectly positioned, the fastener must then be removed and re-attached in another location. If the new fastener hole location is close to the original fastener hole then the wall integrity may be destroyed at the pilot hole site and the fastener will not hold the hanging device or the weight of the object to be hung. The present invention provides a hanging device that can be easily adjusted vertically while the fastener is fixedly mounted and which is has a stable and reliable adjustment mechanism.

Several attempts have been made to provide a hanging device with an adjustable wall hanger location. Schrager, S. H., et al. in U.S. Pat. No. 2,522,901 discloses an adjustable hanging device that has a wall mounted member and a second member upon which one can hang an object to display on a wall. The two members are joined by a free hanging screw that is used to adjust the vertical position of the second member. The device of Schrager, et al. however, is unstable. The second member dangles from the screw and the screw shaft can freely swivel. It is prone to binding and torque if the object to be hung must be moved slightly from touching the wall in order to utilize the screw while the object is hung upon the object hanging member. In addition, the swiveling nature of the screw shaft makes it difficult to engage the slots of the screw head firmly with a tool, such as a screwdriver, and simultaneously apply necessary pressure to rotate the screw.

The adjustable hanging device of Rynearson, F. L., in U.S. Pat. No. 4,566,665, employs a cable and that is secured to an object to be hung, such as a picture, and which cable is threaded through a slot on the hanging device. However, the cable binds the picture and the hanging device together in a manner that makes the picture frame an obstruction that is an impediment to the use of the screw that provides vertical adjustment of the hanging device.

In U.S. Pat. No. 5,878,987, Hayde, G. S. describes an adjustable hanging device that presents as a two member slidable track and slide system. The hanging device of Hayde can be adjusted vertically and may have stability through the use of a track and slide that intimately mate through the entire distance of adjustment. However, the hanging device employs a slide that must be affixed to the object to be hung. It may be undesired or impossible to attach the slide to all objects that one may wish to hang on a wall and thus the hanging device of Hayde is limited in applicability and does not meet the needs of many users of such a device.

Weck, D. et al., in U.S. Pat. No. 7,497,411, describe a hanging device that can be vertically adjusted and is intended to provide added stability. However, the device of Weck, et al. does not provide stability in the adjustment screw movement during adjustment and is prone to wobble, binding, and torque. Stability in the adjustment screw and minimization of wobble or swivel is conferred only when the adjustment screw is fully tightened and two opposing plates in two members mate. That does not provide wobble or swivel stability in any position less than the fully tightened adjustment screw. The fully tightened adjustment does not offer a degree of stable adjustment in any position but one fixed fully tightened position of the adjustment screw.

In U.S. Pat. No. 9,249,929, Callif, A. et al., describe an adjustable hanging device capable of vertical and horizontal adjustment. However, the device of Callif, et al. is not adjustable while the object to be hung is attached to the adjustable hanging device.

The present invention provides a hanging device that has improvements over the prior art devices. The present invention can be adjusted with an adjustment screw that has stable movement throughout its adjustment range. The present invention also is capable of adjustment while the object to be hung is attached to the present invention hanging device and while the device is mounted on a vertical surface. In addition, the present invention allows the user to easily hang and remove an object on the hanging device.

### SUMMARY OF THE INVENTION

It is an object of the present invention to provide an adjustable hanging device that can be vertically adjusted. The present invention includes an adjustment screw to adjust the object that is to be hung while the object is attached to the invention and while the hanging device is mounted on a vertical surface. The adjustable screw is stabilized in its operation to provide more accurate and easily achieved adjustment. In addition, the present invention allows the user to easily hang an object on the hanging device. For example, the object to be hung may be hung on the adjustable hanging device of the present invention by the lip of a picture frame, by a fixed hanging means, such as an metal loop that is affixed to the object to be hung, or by a wire.

### BRIEF DESCRIPTION OF THE DRAWINGS

FIG. 1 illustrates a front view of a first embodiment of the present invention.

FIG. 2 illustrates a close up of the front view of the first embodiment of the present invention showing the adjustment screw in greater detail.

FIG. 3 illustrates a perspective view of the first embodiment of the present invention.

FIG. 4 illustrates a perspective view of a second embodiment of the present invention.

FIG. 5 illustrates a top view of the second embodiment of the present invention.

FIG. 6 illustrates a side view of the second embodiment of the present invention.

### DETAILED DESCRIPTION

The following descriptions are considered to be illustrative of the principles of the present invention and are not intended to be limiting. One of skill in the art will recognize and understand that there are suitable modifications and equivalents that may be used which fall within the scope of the invention described herein. The use of singular forms “a,” “an,” and “the” include plural references unless the context clearly requires otherwise. The embodiments are not limited to those illustrated in the drawings. It should also be understood that the drawings are not necessarily to scale. In certain instances, details may have been omitted that are not necessary for an understanding of the embodiments disclosed herein, for example, conventional fabrication and assembly.

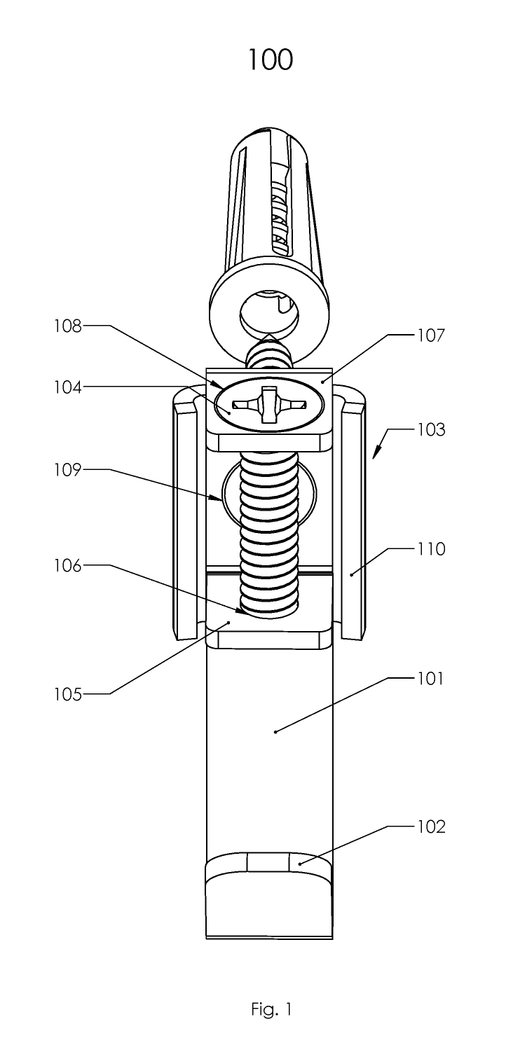

Referring to FIG. 1, an adjustable hanging device, 100, of the present invention comprises a first member, 101, further comprising an adjustable upturned j-shaped hook, 102, capable of supporting an object placed thereon, a second member, 103, having a top portion and a bottom portion. The second member is capable of being fixedly mounted to a solid surface, and an adjustment screw, 104, which adjustment screw, 104, has a shaft, threads, and a screw head, connects the first member to the second member, and provides a range of vertical adjustment of the first member and second member with respect to each other when the screw head is engaged and turned in a clockwise or counter-clockwise manner.

In one embodiment of the present invention, the first member, 101, the second member, 102, and the adjustment screw, 103, are comprised of a metal. However, the present invention may also be comprised of a suitable durable and strong plastic that is capable of holding an object to be hung on the up-turned j-shaped hook, 102.

In one application of the adjustable hanging device of the present invention, the solid surface is a wall.

In the embodiment of the present invention shown in FIG. 1, the first member, 101, further comprises at least one first member plate, 105, formed therein, at an angle perpendicular to or nearly perpendicular to the adjustment screw shaft, which at least one first member plate, 105, is distal and above the j-shaped hook, 102, and a first aperture, 106, which is threaded and is defined within the at least one first member plate, 105. The second member, 103, further comprises at least one second member plate, 107, formed therein at one end of the second member, 103, at an angle perpendicular to or nearly perpendicular to the adjustment screw shaft, and wherein the second member, 103, further comprises a first end and a second end, and which first end and second end vertically oppose each other. The at least one second plate, 107, is located distal and above the at least one first member plate, 105. The at least one second member plate, 107, defines a second aperture, 108, formed therein. The adjustment screw, 103, is passed through the second aperture of the at least one second member plate, 107, and is then threaded into the first aperture, 106, of the at least one first member plate, 105, in order to connect the first member, 101, and the second member, 102, and provide the range of vertical adjustment of the first member, 101, the second member, 102, and the j-shaped hook, 102, with respect to each other. The second member, 103, also has formed therein a third aperture, 109 that is perpendicular or nearly perpendicular to the second aperture, 108, in the at least one second member plate, 107. The third aperture, 109, is used to insert a fastener, for example a screw or a sheathed expansion screw to fixedly attach the present invention to the solid surface.

The present invention may also further comprise more than one first member plate, 105, and more than one second member plate, 107, in order to further stabilize the hanging device.

In FIG. 1, it can also be seen that the adjustable hanging device, 100, may include a stabilization means to prevent sideways movement of the first member during vertical adjustment of the hanging device of the present invention. The stabilization means is shown in this embodiment to comprise at least one side bracket, 110, which at least one side bracket, 110, has a length. The length of the at least one side bracket may be shorter than or at least as long as the range of vertical adjustment provided by the adjustment screw, 104, in order to provide stabilization of the at least one first member, 101, and the j-shaped hook, 102, and which stabilization coincides with at least part or all of the range of adjustment provided by the adjustment screw, 103.

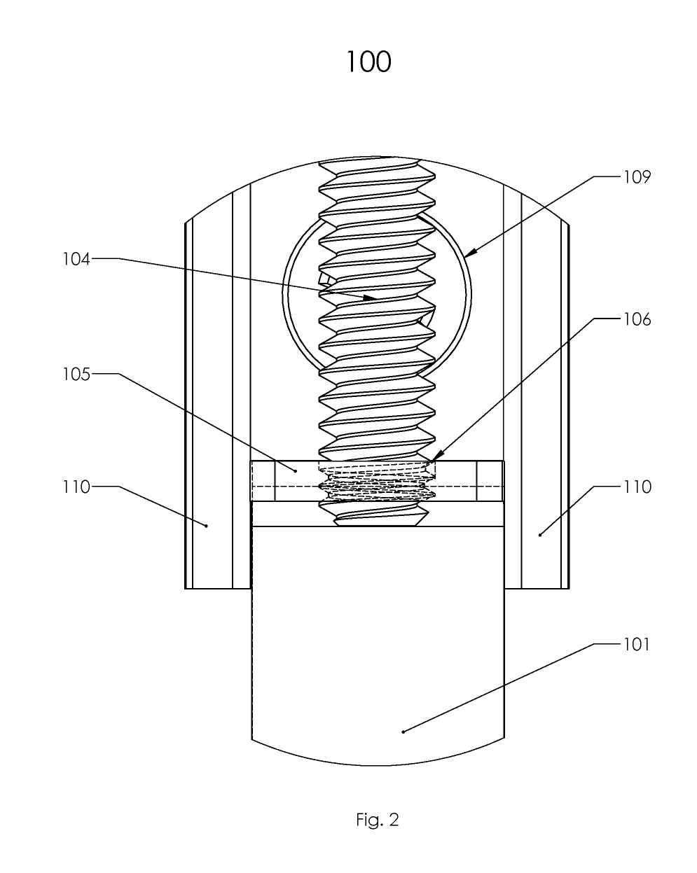

FIG. 2 shows a close-up view of the adjustment screw, 104, of the first embodiment of the present invention and the location of the first aperture, 106, which is threaded and defined within the at least one first member plate, 105. In addition, the at least one second member, 101, the at least one first member plate, 105, the first aperture, 106, the third aperture, 109, and the at least one side bracket, 110, are also illustrated.

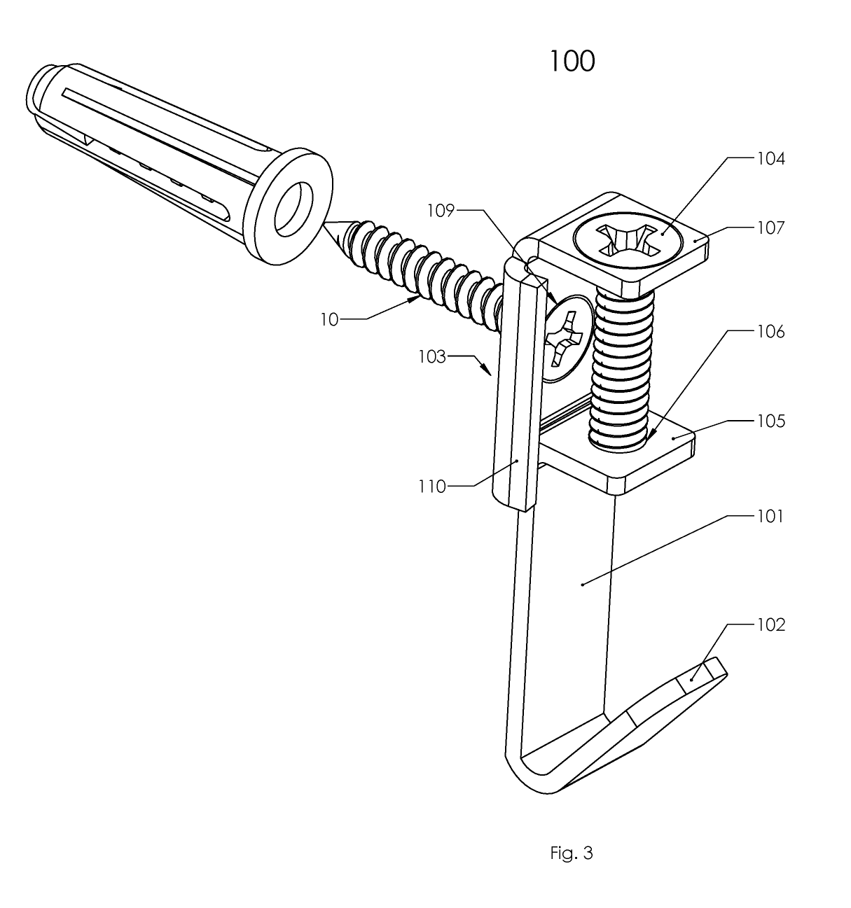

FIG. 3 is a perspective view of the first embodiment of the present invention and shows the interconnection between the first member, 101, and the second member, 103, which is achieved via the adjustment screw, 104. A means of attachment of the second member, 102, is shown as a sheathed screw, 10, that may be used to attach the second member, 102, to a wall.

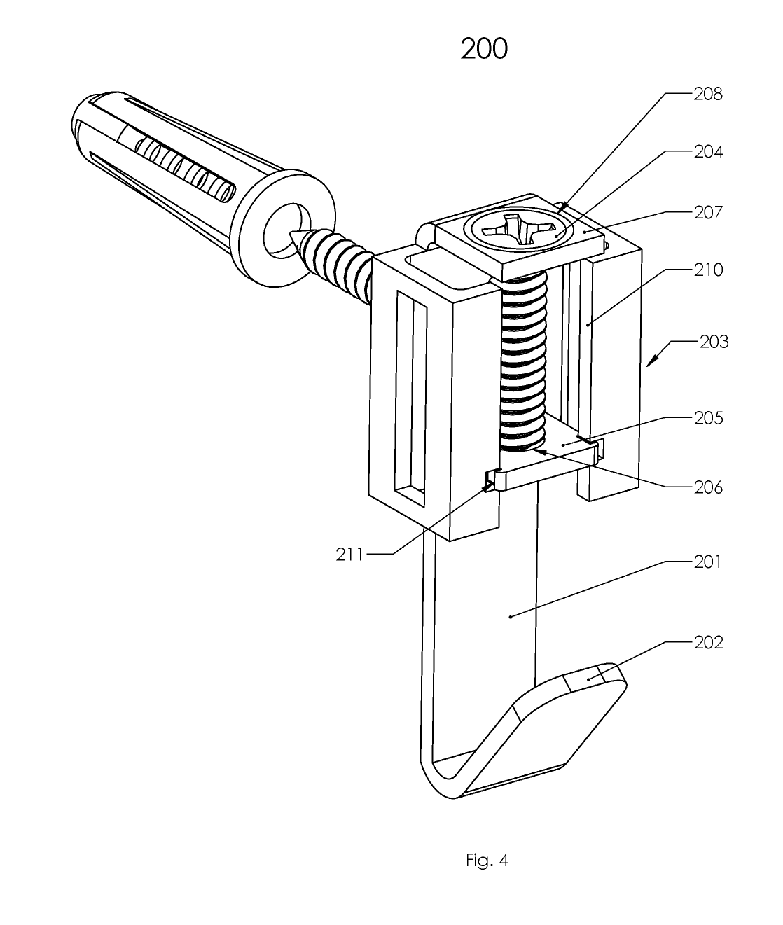

FIG. 4, illustrates a second embodiment of the present invention, 200, in which can be seen, the first member, 201, further comprising the upturned j-shaped hook, 202, a second member, 203, having a top portion and a bottom portion, and the adjustment screw, 204. FIG. 4 also shows the at least one first member plate, 205, formed therein, and a first aperture, 206, which is threaded and which is defined within the at least one first member plate, 205. The second member, 203, further comprises at least one second member plate, 207, formed at one end of the second member, 203. The at least one second member plate, 207, defines a second aperture, 208, therein.

In FIG. 4 the second embodiment may further comprise the stabilization means as at least one fixed vertical wall that is shown here as two fixed vertical walls, 210, formed in the second member 203. In the second embodiment, the at least one first member plate, 205, has at least one notch, 211, that communicates with the two fixed vertical walls, 210, and allows the at least one first member plate, 205, to mate tightly within and slide along the two fixed vertical walls, 210. The at least one notch, 211, is a configuration which may alternatively be used in the first embodiment or any contemplated embodiments of the present invention.

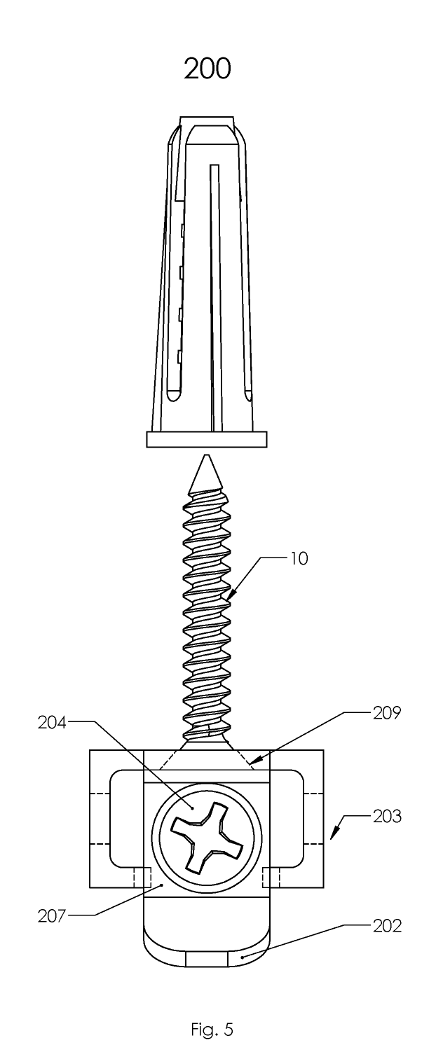

FIG. 5 illustrates a top view of the second embodiment of the present invention and shows the adjustment screw, 204, sitting within the at least one second member plate, 207. In FIG. 5, the location of the third aperture, 209, may be seen. The third aperture is an opening provided to attach the second member, 203, to the vertical surface on which it is to be used. The j-shaped hook, 202, is also illustrated in FIG. 5.

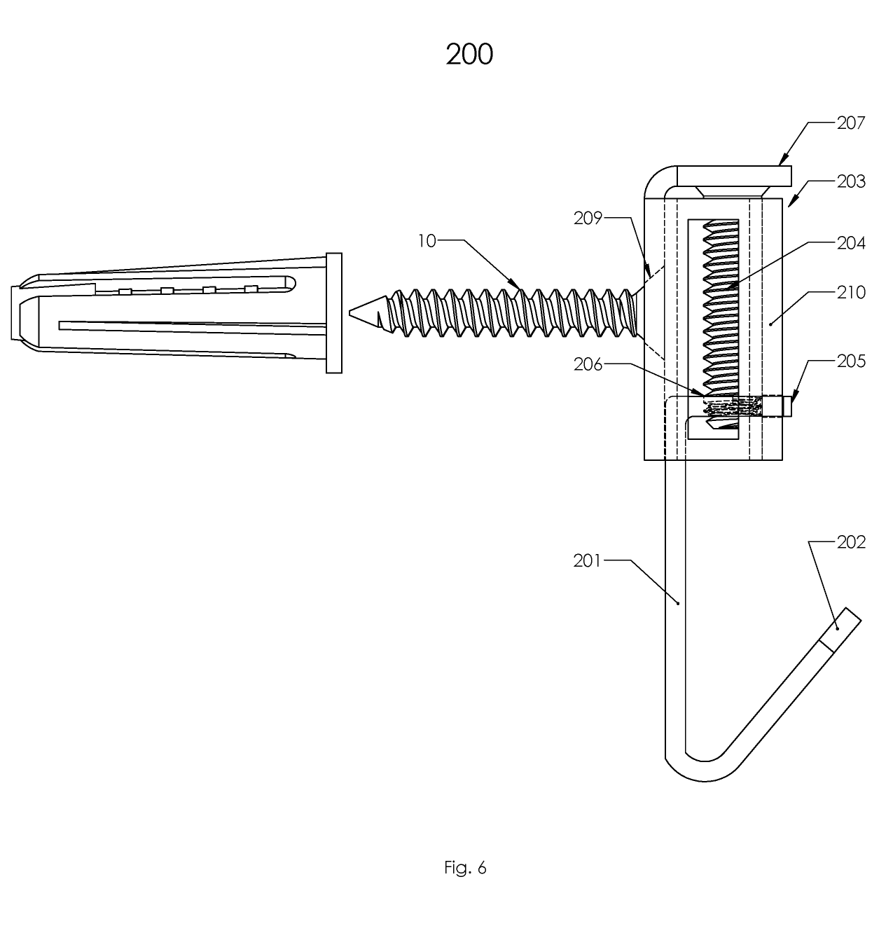

FIG. 6 illustrates a side view of the second embodiment of the present invention. In the second embodiment of the adjustable hanging device of the present invention shown, the two fixed vertical walls, 210, each have a length which is at least as long as the range of adjustment provided by the adjustment screw, 204, in order to provide stabilization of the at least one first member plate, 205, the first member, 201, and the j-shaped hook, 202, and which stabilization is maintained within the range of adjustment provided by the adjustment screw, 204, as it is turned clockwise or counter-clockwise during adjustment of the height of the object. In FIG. 6, one may also see the second member, 203, the at least one second member plate, 207, the first aperture, 206, which is threaded, the third aperture, 209, and the at least one fixed vertical wall, 210

In one embodiment of the invention, the adjustment screw may be a counter sunk flat head screw or a round-headed screw.

In another embodiment, the second aperture or the third aperture may be further comprised of an open straight cylindrical shape in order to accommodate and accept the shaft of the adjustment screw or a wall fastener screw.

In another embodiment of the present invention, the second aperture or the third aperture may be further comprised of a frusto-conical opening to accommodate and accept a counter sunk flat head adjustment screw or a counter sunk flat head wall fastener screw.

In one embodiment, the present invention should be formed of materials designed to hold a minimum of 10 lbs. safely. Optionally, the materials and thickness of materials are those that have tensile or bending strength that will hold a specific weight of materials, for example, 10, 20, 30 or more pounds of weight vertically. Such materials may include but are not limited to any suitable metal such as stainless steel, brass, and titanium.

In one embodiment, the present invention can be fabricated from sheet metal cut by water jet technology or by die-stamping on a cold-rolled-steel (CRS) sheet and subsequent machine bending to form, for example, the first member plate and the second member plate and other portions of the hanging device. In addition, the at least one fixed vertical wall of the present invention may be fabricated, for example by spot welding, or a pour mold of molten metal.

In order to hang an object and adjust using the present invention, 100, the second member, 103, is attached to a vertical surface, such as a wall, using a screw having a head, for example, a sheathed screw that can pass through the third aperture, 109, and be retained on the second member, 101, by the head of the screw. The first member, 101 is interconnected to the second member, 103, The adjustment screw is passed through the second aperture, 108, and then threaded into the first aperture, 106, in order to attach the first member to the second member so that the j-shaped hook, 102, is positioned at the bottom of the device and the second at least one second member plate is distal to the j-shaped hook, 102. An object to be hung upon the wall is placed on the j-shaped hook, 102, and the vertical position of the object is adjusted by turning the adjustment screw, 104, either clockwise or counter-clockwise.

The variations in the elements of the invention will be readily understood by one of skill in the art to be interchangeable with the elements described herein. The descriptions of the hanging device element variations of the present invention are intended to be exemplary and are not intended to be limiting in any way.

1. An adjustable hanging device comprising: a first member further comprising an adjustable upturned j-shaped hook capable of supporting an object placed thereon, a second member, having a top section and a bottom section, wherein the second member is capable of being fixedly mounted to a solid surface, and an adjustment screw which inter-connects the first member to the second member and provides a range of adjustment of the first member and second member with respect to each other.

2. The adjustable hanging device of claim 1 wherein the first member, the second member, and the adjustment screw are comprised of a metal.

3. The adjustable hanging device of claim 1 wherein the solid surface is a wall.

4. The adjustable hanging device of claim 3 wherein the first member further comprises at least one first member plate formed therein, at an angle perpendicular to or nearly perpendicular to the adjustment screw shaft, and which at least one first member plate is distal to the j-shaped hook and defines a first threaded aperture therein,
wherein the second member further comprises
a first end and a second end are formed therein and which first end and second end vertically oppose each other, at least one second member plate, at an angle perpendicular to or nearly perpendicular to the adjustment screw shaft, and wherein the at least one second member plate is positioned distal and above the at least one first member plate,
wherein the second member plate defines a second aperture therein,
wherein the adjustment screw is passed through the second aperture of the second flattened plate and threaded into the first aperture of the first flattened plate in order to connect the first and second members, wherein by turning the adjustment screw, a user may adjust a height location of the first member, and further wherein the second member defines a third aperture to accommodate a wall fastener.

5. The adjustable hanging device of claim 3 further comprising a stabilization means formed in the second member and which the at least one first member plate is slidably engaged within the stabilization means in order to provide further stabilization of the first member.

6. The adjustable hanging device of claim 5 wherein the stabilization means further comprises at least one side bracket formed therein.

7. The adjustable hanging device of claim 6 wherein the stabilization means comprises at least one fixed vertical wall formed in the second member, wherein the at least one fixed vertical wall has a length, and wherein the at least one first member plate has at least one notch which accepts and slidably engages the at least one side bracket.

8. The adjustable hanging device of claim 7 wherein the length of the at least one fixed vertical wall is at least as long as the range of adjustment provided by the adjustment screw in order to provide stabilization of the at least one flattened plate of the first member, and which stabilization coincides with, or is equal to, the range of adjustment provided by the adjustment screw.

9. An adjustable hanging device comprising:
a first member having a body having a first end and a second end, a first member plate extending from the first end, the first member plate having a threaded first aperture, a holding element extending from the second end;
a second member having a back plate having a second member plate having a second aperture axially aligned with the first aperture, a third aperture located in the back plate; and
a screw extending through the second aperture and threaded into the first aperture.

10. The adjustable hanging device of claim 9 wherein the widest portion of the third aperture is narrower than the width of the second member.

11. The adjustable hanging device of claim 10 wherein the width of the third aperture is the widest straight line segment of the third aperture.

12. The adjustable hanging device of claim 9 having at least one side bracket extending from the back plate, the at least one side bracket extending along a majority of the length of the back plate.

13. The adjustable hanging device of claim 12 wherein the at least one side bracket extends along the entire length of the back plate.

14. The adjustable hanging device of claim 12 wherein the at least one side bracket is adjacent to at least a portion of the first member.

15. The adjustable hanging device of claim 9 wherein the widest portion of the third aperture is narrower than the width of the second member; and at least one side bracket extending from the back plate, the at least one side bracket extending along a majority of the length of the back plate.

16. The adjustable hanging device of claim 15 wherein the width of the third aperture is the widest straight line segment of the third aperture.

17. An adjustable hanging device comprising:
a first member having a body having a first end and a second end, a first member plate extending from the first end, the first member plate having a first aperture, a holding element extending from the second end;
a second member having a back plate having a second member plate having a second aperture axially aligned with the first aperture, a third aperture located in the back plate; the widest portion of the third aperture being narrower than the width of the second member; and
a screw extending through the second aperture and the first aperture.

18. The adjustable hanging device of claim 17 wherein the width of the third aperture is the widest straight line segment of the third aperture.

19. The adjustable hanging device of claim 17 wherein the first aperture being threaded.

20. The adjustable hanging device of claim 17 having at least one side bracket extending from the back plate, the at least one side bracket extending along a majority of the length of the back plate.

21. The adjustable hanging device of claim 20 wherein the at least one side bracket extends along the entire length of the back plate.

22. The adjustable hanging device of claim 20 wherein the at least one side bracket is adjacent to at least a portion of the first member.

23. The adjustable hanging device of claim 17 wherein the first aperture being threaded; and at least one side bracket extending from the back plate, the at least one side bracket extending along a majority of the length of the back plate.

24. An adjustable hanging device comprising:
a first member having a body having a first end and a second end, a first member plate extending from the first end, the first member plate having a first aperture, a holding element extending from the second end;
a second member having a back plate having a second member plate having a second aperture axially aligned with the first aperture, a third aperture located in the back plate, and at least one side bracket extending from the back plate, the at least one side bracket extending along a majority of the length of the back plate; and
a screw extending through the second aperture and the first aperture.

25. The adjustable hanging device of claim 24 wherein the at least one side bracket extends along the entire length of the back plate.

26. The adjustable hanging device of claim 24 wherein the at least one side bracket is adjacent to at least a portion of the first member.

27. The adjustable hanging device of claim 24 wherein the first aperture being threaded.

28. The adjustable hanging device of claim 24 wherein the widest portion of the third aperture is narrower than the width of the second member.

29. The adjustable hanging device of claim 28 wherein the width of the third aperture is the widest straight line segment of the third aperture.

30. The adjustable hanging device of claim 24 wherein the at least one side bracket extends along the entire length of the back plate.

31. The adjustable hanging device of claim 24 wherein the at least one side bracket is adjacent to at least a portion of the first member.

32. The adjustable hanging device of claim 24 wherein the first aperture being threaded; and the widest portion of the third aperture is narrower than the width of the second member.

33. The adjustable hanging device of claim 32 wherein the width of the third aperture is the widest straight line segment of the third aperture.
